(19) United States
(12) Patent Application Publication
(10) Pub. No.: US 2021/0014353 A1
(43) Pub. Date: Jan. 14, 2021

(54) METHODS, SYSTEMS, APPARATUSES, AND DEVICES FOR FACILITATING MANAGING CONNECTIONS FROM ONE OR MORE CALLER DEVICES

(71) Applicants: Yuanjie Li, Mountain View, CA (US); Songwu Lu, Woodland Hills, CA (US); Chunyi Peng, West Lafayette, IN (US)

(72) Inventors: Yuanjie Li, Mountain View, CA (US); Songwu Lu, Woodland Hills, CA (US); Chunyi Peng, West Lafayette, IN (US)

(21) Appl. No.: 16/924,166

(22) Filed: Jul. 8, 2020

Related U.S. Application Data
(60) Provisional application No. 62/871,572, filed on Jul. 8, 2019.

(51) Int. Cl. H04M 3/22; H04M 3/42; H04M 7/00; H04L 29/06; H04M 3/436

(52) U.S. Cl. CPC H04M 3/2281; H04M 3/42059; H04M 7/0078; H04M 2203/6027; H04L 65/1006; H04L 63/18; H04M 3/4365; H04L 65/1079

(57) ABSTRACT

Disclosed herein is a callee device for detecting a spoofed call from a caller device. Further, the callee device may include a communication device and a processing device. Further, the communication device may be configured for receiving a first connection request from a first caller device of the caller devices and receiving at least one signaling message from a second caller device of the caller devices. Further, the processing device may be configured for initiating a second connection to the second caller device based on the caller identification, determining an inferred call state based on the at least one signaling message, comparing an expected call state of the first caller device and the inferred call state based on the determining of the inferred call state, determining an indication of spoofing based on the comparing, and performing an action based on the determining of the indication of the spoofing.

The current application claims a priority to the U.S. Provisional Patent application serial number 62/871,572 filed on Jul. 8, 2019.

### FIELD OF THE INVENTION

Generally, the present disclosure relates to the field of telecommunications. More specifically, the present disclosure relates to methods, systems, apparatuses, and devices for facilitating secure voice connections and detecting a spoofed call from one or more caller devices.

### BACKGROUND OF THE INVENTION

Voice call has been a communication service for mobile users for decades. Despite the various security mechanisms deployed inside the carrier infrastructure and the device OS, a substantial number of telephony frauds, including scam calls, spam calls, and voice phishing, have been reported and repeatedly experiences by mobile users. A simple, yet menacing attack technique behind telephony frauds is through caller ID spoofing. The attacker acts as the caller and spoofs its caller ID (i.e., the caller name or phone number or other identities) to pretend to be someone else. Upon receiving the call, the victim is deceived to believe that the call comes from the “authentic” caller indicated by the spoofed ID (e.g., government agencies, public and utility services, banks, insurances, etc). The victim is trapped to leak confidential information to the attacker during the call, resulting in business, property, or monetary losses. In recent years, the number of victims suffered from telephony fraud has been growing at an alarming rate. Scam calls have been regularly reported, and imposter scam has been the top source of consumer complaints according to the Federal Trade Commission report in 2017 and 2018.

Further, Caller ID spoofing is easy to launch, but hard to defend. Caller ID spoofing is offered as a public service such as Spoofcard, Spooftel, FakeCall, and many apps alike. This makes it easy for an attacker to forge the phone number of the trusted caller and make the call appears to come from the “correct” number. Existing defense solutions include approaches of building a global certificate authority for end-to-end caller authentication (e.g., a public key infrastructure (PKI) to authenticate each party before call setup), enabling network assistance on caller verification (i.e., authentication required at the gateway during call setup), launching challenge-and-response to verify the true caller (e.g., requiring the caller to respond to a short message or a call), etc. However, these proposals are deemed practically ineffective due to the heavy deployment cost and major updates on the telephony systems (third-party global infrastructure, network infrastructure upgrade, or changes on all possible callers (every phone)). As a result, there exists a strong need for a defense that is effective against caller ID spoofing, and incurs low deployment costs (e.g., with the callee-only capability).

Existing techniques for managing connections from one or more caller devices are deficient with regard to several aspects. For instance, current technologies incur heavy deployment costs. Furthermore, current technologies require major infrastructure upgrades in the telephony systems.

Therefore, there is a need for improved methods, systems, apparatuses, and devices for facilitating managing connections from one or more caller devices that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a callee of facilitating managing secure voice connections from one or more caller devices, in accordance with some embodiments. Accordingly, the callee device may be connectable to the one or more caller devices for establishing a connection with the one or more caller devices. Further, the callee device may include a communication device and a processing device. Further, the communication device may be configured for receiving a first connection request associated with a first connection from a first caller device of the one or more caller devices. Further, the first connection request may include a caller identification associated with the first caller device. Further, the communication device may be configured for receiving at least one signaling message from a second caller device of the one or more caller devices. Further, the processing device may be configured for initiating a second connection to the second caller device based on the caller identification. Further, the processing device may be configured for determining an inferred call state associated with the second caller device based on the at least one signaling message. Further, the processing device may be configured for comparing an expected call state of the first caller device and the inferred call state based on the determining of the inferred call state. Further, the processing device may be configured for determining an indication of spoofing associated with the first caller device based on the comparing. Further, the processing device may be configured for performing at least one action based on the determining of the indication of the spoofing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 depicts a basic call setup procedure with caller ID spoofing, in accordance with some embodiments.

FIG. 2 is a timing diagram depicting multi-phase verification, in accordance with some embodiments.

FIG. 3 depicts the overview and main operation flow, in accordance with some embodiments.

FIG. 4 depicts the examples of call setup signaling message sequences in three call scenarios using SIP (VoLTE), in accordance with exemplary embodiments.

FIG. 5 depicts a sequence pattern extraction, in accordance with some embodiments.

FIG. 6 depicts a training procedure, in accordance with some embodiments.

FIG. 7 depicts multi-phase spoofing inference logic, in accordance with some embodiments.

FIG. 8 depicts callee states, in accordance with some embodiments.

FIG. 9 depicts seven typical call scenarios including one no-spoof scenario and several basic and advanced spoofing ones, in accordance with exemplary embodiments.

FIG. 10 is a block diagram of a callee device for facilitating managing connections from one or more caller devices, in accordance with some embodiments.

FIG. 11 is a block diagram of a callee device for facilitating managing connections from one or more caller devices, in accordance with some embodiments.

FIG. 12 is an illustration of an online platform consistent with various embodiments of the present disclosure.

FIG. 13 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses and devices for facilitating managing connections from one or more caller devices, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes systems and methods for detecting and/or preventing incoming spoof calls are provided. Further, the methods use the callee-only capabilities. It includes strategically dialing one or multiple outgoing calls (connection) associated with an incoming call (connection), inferring call states using the call setup signaling data received, and determining if the incoming call intended for the callee device is a spoof call, where the caller identifier received in the incoming call is forged and associated with another number. Further, the systems may be deployable at the callee devices only and/or at the callee's carrier network infrastructure.

Further, the present disclosure covers a large class of practical spoofing attacks against mobile phone users (such as users). The attack is initiated by malicious users, who have full control of the phone devices. It is not from their mobile carriers. The attack can be launched by leveraging public service/software or running private programs for designated attack operations. The adversary can not only make a spoofed call request to the victim callee but also manipulate other call parties through legitimate access interfaces for advanced attacks. For example, the adversary, say, Eve, can forge the phone number of one target caller, say, Alice, make the call through to the callee, say, Bob. In the meanwhile, the adversary can dial the true caller or even establish another call with Alice accompanying the spoofed call; the adversary can further adjust attack frequency and modify dial/call operations. However, the attacker has no ability to hijack or compromise the victim's phone, the true caller's device, or their carrier networks. No malware can be installed; the true caller does not conspire with the adversary; the carrier network infrastructure also functions well. In short, the victim callee, the true caller, and their carrier networks are all trustworthy.

Further, the present disclosure describes a method and a system for detecting and/or preventing incoming spoof calls.

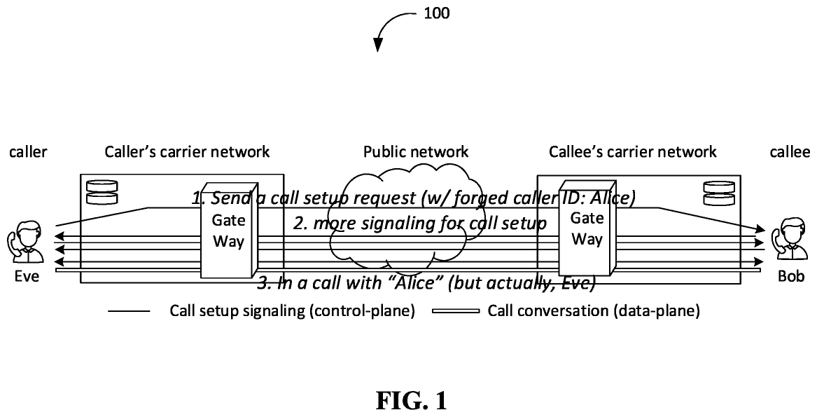

FIG. 1 depicts a basic call setup procedure 100 with caller ID spoofing, in accordance with some embodiments. Further, FIG. 1 may depict all the involved parties (caller, callee, and the carrier networks of callee and caller), as well as generic call setup procedure 100 with caller ID spoofing. For simplicity, E is used for Eve (attacker of caller ID spoofing), A is used for Alice (the authentic user with caller ID used in the call), and B is used for Bob (the callee victim). Call signaling runs first to establish a call session and then starts voice conversations over the session. The signaling starts with a setup request from the caller to the callee, followed by more signaling required by the call setup procedure 100. Both parties obtain call service from the carrier network (CN) associated with both parties. CNs are interconnected (say, via a public telephony network), so that call parties from different CNs may talk to each other. Each call party has a globally unique ID, often a telephone number (e.g., +1 XXX-XXX-XXXX). ID acts as a permanent address-of-record which is assigned upon subscription and is authenticated before use. Specifically, cellular networks run Authentication and Key Agreement (AKA), which uses the shared secret key stored at SIM (locally) and known only to the operator (user database) to authenticate each other. Further, the callee's cellular network (CN) such as 5G/4G/3G/2G. 3G and 2G may support conventional circuit switched (CS) calls. Further, 4G and 5G support two voice solutions. Further, the two voice solutions may include a Voice-over-LTE (VoLTE) and a Circuit Switched FallBack (CSFB). Further, the VoLTE adopts Voice-over-IP (VoIP) and carries voice calls (and its signaling) in IP packets. Further, the CSFB leverages legacy 3G/2G networks to provide CS voice calls. Further, the VoLTE and the CSFB may support similar call setup signaling but use different protocols. Further, the VoLTE uses Session Initiation Protocol (SIP) while CSFB and CS calls use Call Control (CC). Further, the VoLTE and the CSFB may be associated with different protocol languages, e.g., the first request via INVITE in SIP for VoLTE and via SETUP in CC for CSFB/CS. Further, the translation is handled by the border gateways of the VoLTE and the CSFB, for inter-operability. For example, INVITE is mapped into SETUP once leaving 4G and entering 3G/2G. The usage of the VoLTE and the CSFB for signaling messages are introduced in the standard specifications of the VoLTE and the CSFB.

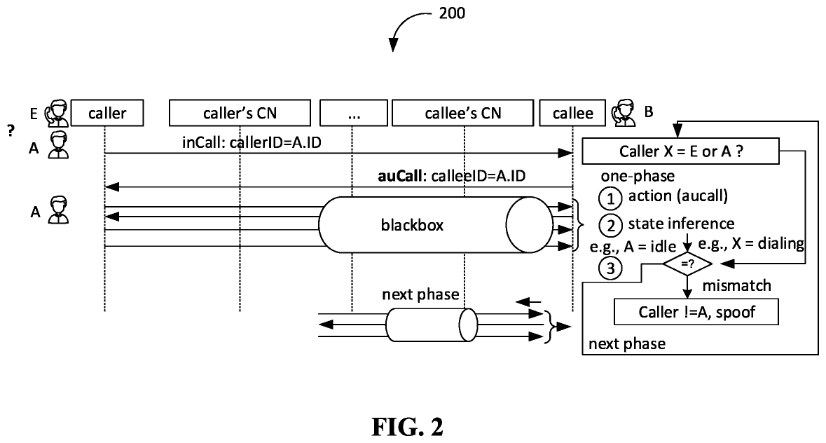

FIG. 2 is a timing diagram 200 depicting multi-phase verification, in accordance with some embodiments. The multi-phase verification includes verifying whether the caller ID (A.ID) is spoofed or not, by comparing the call states of two call sessions. For an incoming call inCall, the present disclosure may ask the callee (i.e., B) to dial an auCall back to the originating ID (\textcircled{1}). B makes use of the inCall's context to infer the state of caller X (A or E in the absence/presence of spoofing). For example, X is dialing when inCall rings. Meanwhile, B uses its own observation on auCall to infer A's call state \textcircled{2} and compares it with X's (\textcircled{3}). If mismatch happens, A is asserted to be not X, and spoofing happens to inCall.

The above simple solution concept has several nice features. No control is assumed on other components (the carrier infrastructure, or other devices). It does not require cooperation by other parties or extra information access. It also works under two premises: (1) B's observation is able to infer A's distinct call state. When the call state of auCall. Callee (here, A) changes, the observation at auCall. Caller (here, B) should also change to make the inference possible. (2) The inferred A's call state should differ from the true call state at least once upon spoofing. If both premises hold true and the present disclosure may detect the presence of caller ID spoofing.

Further, the present disclosure seeks to exploit the callee-side capability only to timely verify whether an incoming call is truly associated with its authentic caller ID. Further, the present disclosure may allow the callee to proactively and strategically call back (auCall) to the originating ID until the spoofing hypothesis [symbol] is validated.

$$Once ℋ ℋ \text{:} \{ \begin{matrix}True , & inCall . Caller \neq auCall . Callee \\ False , & inCall . Caller = auCall . Callee\end{matrix} \qquad ( 1 )$$

is accepted, inCall is marked as a spoof; otherwise, no-spoof. The original problem is to validate whether inCall. CallerID is associated with inCall. Caller. Because each caller ID matches only one unique entity, auCall reaches the callee associated with inCall. callerID as long as the carrier functions normally In order to validate H and assert inCall is a spoof, there must be one mismatch between call state of inCall and (auCall), Namely,

∃i, Ωᵢ(inCall. Caller) ≠ Ωᵢ(au.Call. Callee) [symbol] spoof, (2)

wherein Ωi(X) denotes X's call state at time i. Otherwise, inCall may be no-spoof when the call state of inCall and (auCall) matches every time.

∀ᵢ, Ωᵢ(X)=Ωᵢ(A) [symbol] no-spoof.

Further, rules (2) and (3) is applied to infer spoofing. In the illustrative example in FIG. 2, Ω₁(inCall. Caller)=dialing and Ω₁(auCall. Callee)=idle. A mismatch is found in the first phase, the detection completes at the first phase. If a mismatch is not found yet, the present disclosure runs another phase with the aforementioned three steps (taking action for another auCall, inferring call states, comparing states for detection).

Note that the procedure may be same when the callee's CN (say, B's CN) implements the present disclosure except that B's CN may run the procedure without notifying B. That is, the callee's CN may choose to detect the presence of caller ID spoofing first and then forward the call that passes the caller ID spoofing detection test (no-spoof) to the callee later.

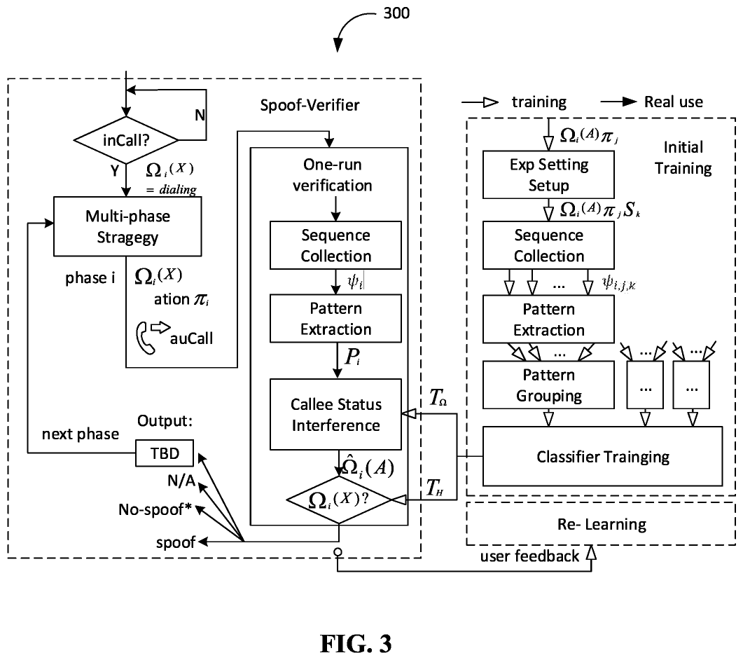

FIG. 3 depicts the overview and main operation flow 300, in accordance with some embodiments. Further, the main operation may include a core module. Further, the core module may be a spoof-verifier. Further, the spoof-verifier may be used for runtime spoofing detection of a call. Further, the present disclosure may devise a multi-phase (mostly two-phase) verification strategy because the aforementioned one-run verification may not always suffice in practice. The initial phase starts with Ω₁ (X)=dialing the first auCall while inCall is ringing; At each phase possibly with distinct Ωᵢ (X) (dialing or connected), the present disclosure may perform a one-run verification. Specifically, the present disclosure may perform an action πᵢ (make one auCall) and exploit the received sequence of call setup signaling messages to infer \hat{Ω}ᵢ(A) the state of the originating ID and determine whether the spoofing incurs by comparing with i(XΩ)ᵢ(X). Further, the present disclosure may apply to Eqn. (2) to ascertain spoof. If both states match at all the phases, the present disclosure indicates no-spoof*. Further, it is unnecessary to make an auCall through because the call setup signaling messages is invoked as long as the call is dialed. The verification may hang up the auCall once sufficient signaling messages are received. Further, the present disclosure may not be 100% confident in no-spoof inference because the present disclosure uses a limited number of phases in practice; This cannot guarantee Eqn. (3) holds true in any case. Due to the attacker's manipulation and the existing uncertainties, a match is possible when X ≠ A (spoof). Consequently, it is to be determined (TBD) when a match is observed, and not all the phases complete. If so, the next phase will be invoked accordingly, for example, making another auCall when inCall is answered and Ωᵢ(X)=conn.

The modules of initial training and re-learning are to train and update decision tree rules (classifiers) used by the spoof-verifier. The former is mandatory and requires a one-time effort before use. The latter is optional and can update rules with user feedbacks (labeled samples) after use. Further, the present disclosure may learn the rules for two reasons. First, the raw observation is a sequence of messages which has a relatively high dimension, while the effective patterns lie in a much smaller subspace. The rules based on the original sequence is prone to more variants (caused by irrelevant messages) and this becomes harder to bootstrap accurate classifiers (T_{Ω} and T_{H}) for call state inference and H-validation, especially using a small number of samples at the start. To this end, the present disclosure leverages domain knowledge on call setup and extract useful features (sub-sequence) for the present disclosure's need. Second, no single rule may fit all. Further, the present disclosure must handle sequence variants in reality and ensure its effectiveness under a variety of unknown factors like caller's carrier, call technology, call configurations, and operations, etc. The rules are specific to the victim callee's carrier and call technology (voice-over-LTE (VoLTE), circuit-switched calls (CS), or circuit-switched fallback (CSFB)). There is no surprise that the rules learned may be shared with the same-type mobile users using the same carrier and call technology. The training effort is modest.

Initial Training

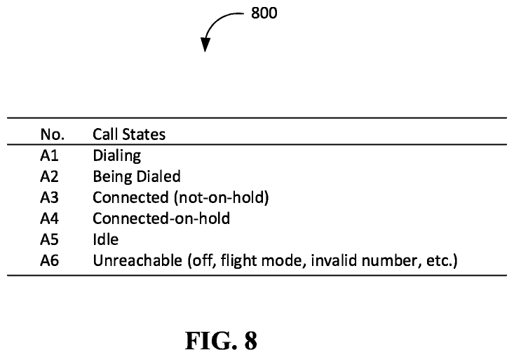

The initial training takes three steps: sample collection, pattern extraction, and classifier training.
Sample collection—The present disclosure conducts experiments to collect samples to infer the callee status from the caller's observation. The inference is not affected by B's inCall status (whether it is on another ongoing call or just idle), so the present disclosure considers the auCall call session only. Given the output label of the callee's status Ωᵢ(A), the present disclosure may collect training samples under two settings: the caller's call action πⱼ under control and typical experimental settings sₖ which might be unknown in use. FIG. 8 depicts callee states 800, in accordance with some embodiments. Further, the callee states 800 may include six common callee states A1-A6. The present disclosure considers four output labels: dialing (A1), connected (A3), idle (A5), and unavailable (A6). This is because the preliminary study indicates that four call states are sufficient for high-accuracy detection, while A1 and A2 are not distinguishable, A3 and A4 are almost indistinguishable in reality. Action πⱼ is constrained by the caller's power and the present disclosure considers VoLTE and CSFB/CS calls. Experimental setting Sk takes into account other factors such as the callee's carrier and call technology (VoLTE, CSFB, landline), voice service configuration, etc. In each run r, the present disclosure may collect one raw sequence sample for ψ_{i,j,k}[r].

Further, the present disclosure may not enumerate all possible experimental settings (which is extremely hard, if not impossible). Further, the training quickly converges with several samples in typical settings. This is because the key patterns are commonly observed due to the inherent call setup signaling finite-state machine (FSM).
Pattern Extraction—Further, the present disclosure may extract low-dimensional features out of the raw sequences for further inference. Further, the present disclosure may take a domain-specific approach over two facts: (i) the sequence of signaling messages is structural (determined by its inherent FSM); (ii) many segments are common, but only a few distinct segments are critical to inference.

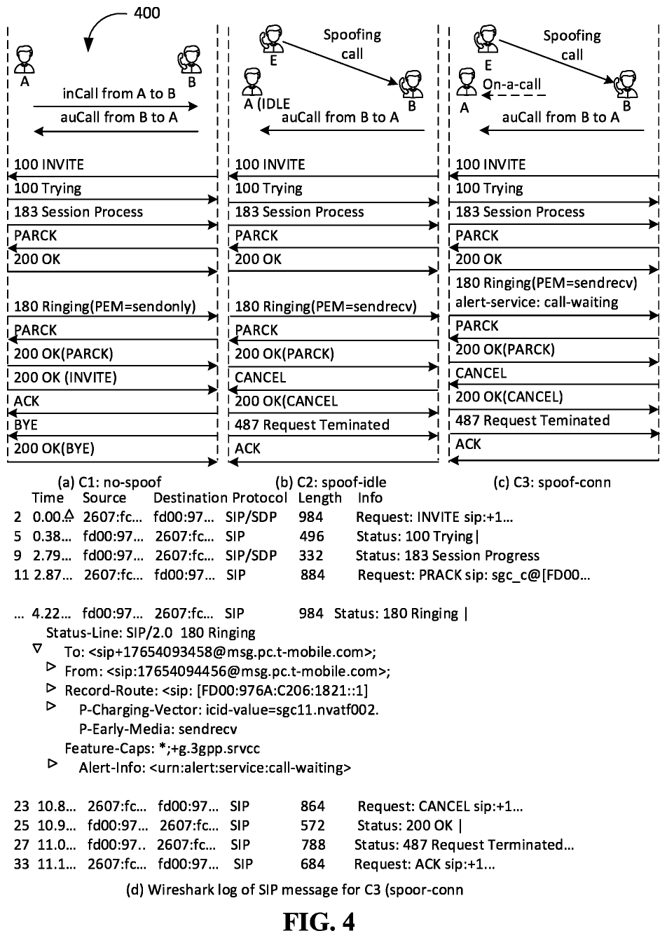

Without loss of generality, the present disclosure may use VoLTE (SIP signaling messages) to illustrate the pattern extraction procedure. It is applicable to other call technologies like CSFB and CS calls. Further, FIG. 4 may exemplify the diagrams of SIP signaling messages observed at B in three common call settings:

(C1) A calls B (no-spoof),

(C2) E calls B while A is idle (spoof-idle),

(C3) E calls B while A is on a call (spoof-conn).

FIG. 4 depicts the examples of call setup signaling message sequences 400 in three call scenarios using SIP (VoLTE), in accordance with exemplary embodiments.

B uses VoLTE (SIP) in T-Mobile. In this example, the present disclosure may make three observations. First, the sequences of call signaling messages share many common parts in all three scenarios. Specifically, all start with INVITE, followed by 100→183→ ⋅⋅⋅→180 ⋅⋅⋅ →200 ⋅⋅⋅ . Further, the numbers represent the SIP state and response codes, all of which are standardized in RFC 3261 (SIP standard specification). Second, each sequence contains certain critical information to distinguish three call settings. For example, in the received 180 Ringing message, there are two fields: P-Early-Media (PEM) and Alert-Info (detailed logs in FIG. 4d). Third, the present disclosure may also discover redundant features which can infer distinct call state as well. C1 observes 200 but C2/C3 uses 487 Request Terminated in response to INVITE; C1 uses BYE while C2/C3 uses CANCEL at the end. Consequently, the present disclosure may infer distinct callee state: dialing (C1), idle (C2) and conn (C3) (Premise 1) while the inferred state in C2/C3 differs from the anticipated state in the absence of spoofing (C1) (Premise 2).

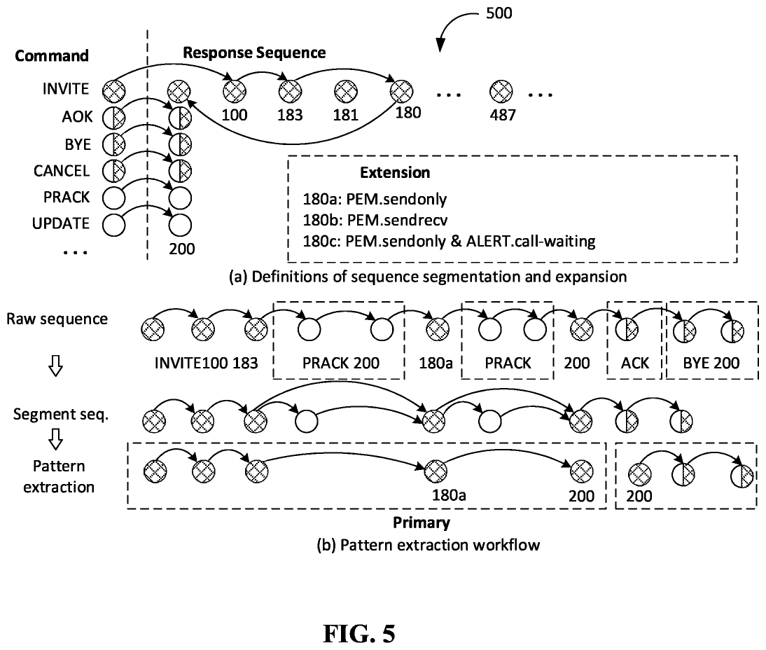

FIG. 5 depicts a sequence pattern extraction 500, in accordance with some embodiments. Further, the pattern extraction 500 has two steps. First, the raw sequence is represented in a simple and meaningful manner Further, a VoLTE (SIP signaling messages) may be used to illustrate the segment structure. Each segment starts with a signaling command or request (e.g., INVITE, ACK, OPTION, BYE, CANCEL, PRACK, and UPDATE), and ends with its response codes (zero, one or multiple). As a result, each segment has its call signaling context. The INVITE segment is used to invoke call signaling, while the ACK/BYE/CANCEL is to stop signaling. Other segments like PRACK and UPDATE are used for other purposes and irrelevant to call status inference (0). Further, all segments except INVITE have at most one response code (usually 200 or no response). This implies that only its segment head (aka, the request itself) suffices. The INVITE request not only invokes multiple response codes, but also exhibit complicated patterns, such as 183-183-487, 183-180-487, 183-180-200, and so on. Moreover, certain response codes have multiple variants such as 180/183 (with distinct PEM and ALERT values). Further, the response code obtains multiple extensions based on the additional information carried. Further, the raw sequence may be represented into a segment sequence by substituting all non-INVITE segments with its command head only.

Second, the present disclosure may extract the pattern in the form of one primary segment (INVITE), along with one secondary segment. Primary and secondary segments are defined based on the importance of the inference of the primary and the secondary segments. It is not surprising that the INVITE segment plays an essential role (●). Other segments like ACK/BYE/CANCEL are useful and act as the secondary ones ( [symbol] ). Further, the significance of the other segments is not only justified by the meanings of the other segments but also is confirmed in the training process. Finally, the present disclosure may retrieve the pattern as one sole INVITE segment (here, INVITE-100-183-180a-200) and a chain of the secondary ones (here, ACK-BYE) followed by a primary segment element, here 200 (for INVITE), which records how to chain two segments. Further, the present disclosure may greatly reduce the feature space while still retaining key information.
Classifier Training—The last step is to train the classifiers T_{Ω} and T_{H}. The approaches for training the classifiers are similar and the only difference is that the latter is a binary classification, which is simpler. Given Ωᵢ(A), the present disclosure may only consider two sets: match Ωᵢ(A)) and mismatch ¬Ωᵢ(A)). In the former T_{Ω} training, the present disclosure may handle multiple labels (here, A1, A3 and A5, and A6). Consider the classifier is call technology-specific. The training runs separately per πⱼ (VoLTE or CSFB/CS).

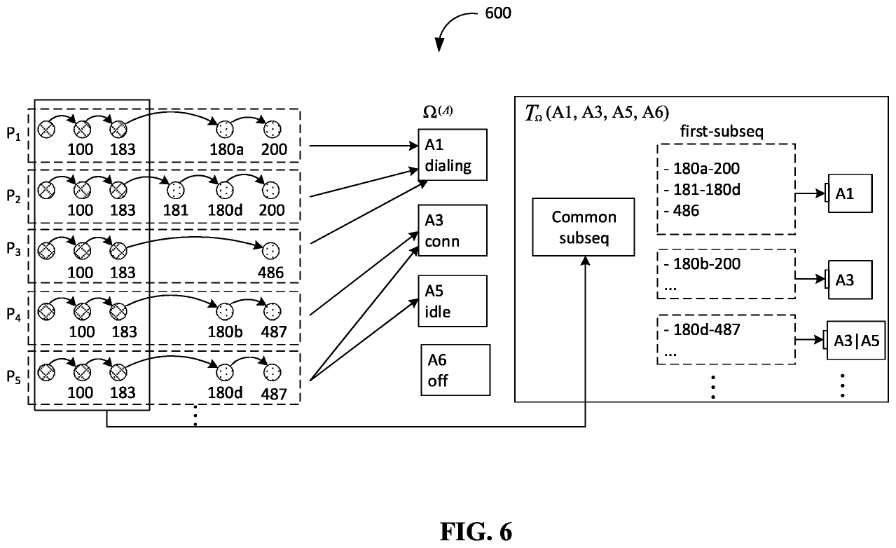

FIG. 6 depicts a training procedure 600, in accordance with some embodiments. The training input is a bipartite graph that maps the pattern to the status label. Further, not every pattern corresponds to a single label. For example, pattern P₅ is observed in both A3 (conn) and A5 (idle). This results in ambiguity, so the present disclosure may not precisely tell the callee status in use. Further, the training may remap all the patterns to new status labels so that every pattern contains no ambiguity. This is crucial for the subsequent spoofing inference. The present disclosure utilizes it to determine the confidence level of the inference. To do so, the present disclosure may group all the patterns per Ωᵢ(A) and then divide the groups into exclusive sets. Further, the patterns that are associated with multiple labels the present disclosure may create a new label. For example, P₅ is labeled as A3|A5, which is different from A3 only or A5 only. Initially, the exclusive sets may be obtained via set interaction and difference. For two sets A and B may be divided into three new sets: A ∩ B, A/B (A only), B/A (B only). Theoretically, n (here, n=4) groups may be converted into at most 2ⁿ−1(=Cₙ¹+Cₙ²+ ⋅ ⋅ ⋅ +Cₙⁿ) sets. Further, the present disclosure may create sets iteratively. When a new sample (Pₓ, Aₓ) comes, the present disclosure checks if the extracted pattern is new. If yes, Pₓ will be added into its Aₓ₋only set. If no, the present disclosure may check if its new label conflicts with the existing label (A_{old}. When the new label is not included, the present disclosure may move this pattern into the set labeled as Aₓ|A_{old}. In fact, the present disclosure may iteratively perform the above process until the present disclosure finishes all the training samples.

Further, the present disclosure may take two measures in training. First, the present disclosure may locate common subsequences that appear in all patterns for distinct callee status. Further, the common subsequences are of no value for inference. Further, the present disclosure may apply the popular LCS (Longest Common Subsequence) algorithm. Further, the present disclosure may run it iteratively until the present disclosure finds all common subsequences. In this example, the present disclosure may identify a common subsequence of the first three messages (INVITE-100-183). Second, the classifiers may use the first distinct subsequence, rather than the whole pattern sequence. Further, the present disclosure may apply FreeSpan, a sequential pattern mining algorithm to generate unique subsequence patterns. Further, the first distinct subsequence is sufficient to classify different callee statuses. For example, after the common subsequence, 180a or 181 or 486 infers A1 (dialing) but 180d indicates A3|A5. This speeds up spoofing interference without waiting for all the messages. Further, the first distinct subsequence may vary as training samples grow. One pattern may change its label upon a new sample. To handle this, the present disclosure may still perform the training for the whole pattern sequence (primary and secondary segments). Once the first subsequence expires, the present disclosure may leverage the rest subsequences (redundant features) to update the first unique subsequence.

Spoof Verifier

The module of Spoof Verifier has two main components: multi-phase verification strategy and one-run verification.
One-run verification—Each verification starts with known Ωᵢ(X) and actions πᵢ at phase i. Following the operation flow 300 of FIG. 3, it uses many common components in the training process. Further, One-run verification is associated with three distinct operations.

First, direct spoofing inference. Further, the present disclosure may check whether the observed pattern matches Ωᵢ(X), without inferring \hat{Ω}ᵢ(A). Moreover, Ωᵢ(X) may not be an arbitrary state, as shown in FIG. 8. Due to the incoming call constraints, there are only two (actually three) options: (1) when inCall still rings, Ωᵢ(X) is dialing; (2) when inCall is accepted, Ωᵢ(X) is connected (no difference in not-on-hold or on-hold).

Second, the present disclosure may run an online algorithm for inference. This accelerates the process without waiting for all the signaling messages to come. Upon receiving a new signaling message, the present disclosure may update its pattern incrementally. Once the update is able to validate \hat{Ω}ᵢ(A) ≠ Ωᵢ(X) spoof is detected; the present disclosure may stop data collection and verification (e.g., stop dialing or hang up this auCall). Otherwise, the present disclosure may stop until the present disclosure receives all the signaling messages. Further, the present disclosure may use the first unique subsequence at runtime in order to complete the spoofing inference early. Further, the other design options to defer inference uses multiple subsequences (if possible) for reliable inference. Further, certain signaling messages are not invoked until the auCall is not hung up. Further, the present disclosure may add a timer to hang up the call to avoid waiting too long.

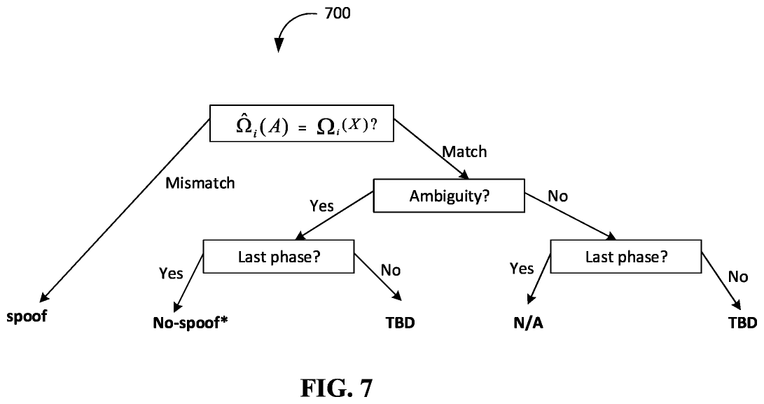

Third, the inference decision logic of the present disclosure is slightly different. In the training process, the ground truth is known. But in the inference process, the present disclosure may face more uncertainties. FIG. 7 depicts multi-phase spoofing inference logic 700, in accordance with some embodiments As illustrated in FIG. 7, the decision tree at each phase has four outputs. If it does not match any pattern for Ωᵢ(X), it stops with ‘spoof’. This is the easiest case. Otherwise, the used pattern contains any ambiguity, namely marked with more than one call states. If no, it stops at ‘no-spoof*’ if this is the last phase, otherwise ‘TBD’ for the next phase. If yes, it stops at ‘N/A’ if this is the last phase, otherwise ‘TBD’ for the next phase. Further, the ‘N/A’ may include an alternative aggressive option. Further, the alternative aggressive option may include marking the ‘N/A’ as ‘no-spoof*’ with lower confidence than the last phase ‘no-spoof’. However, it may generate false-negative results (the present disclosure says ‘no-spoof’ when it is a spoof). Further, the present disclosure may choose the current one because the false negative is more damaging In contrast, marking true negative (no-spoof) as N/A may not be a big concern. Given N/A, the callee may stay alert than usual, which is unnecessary when it is not a spoof. Moreover, the callee may be relaxed after learning the call is not ill-intended over the conversation.
Multi-phase verification strategy: Clearly, reducing ambiguity is critical. When one pattern has multiple state labels, one of which matches with Ωᵢ(X), it is hard to ensure inference accuracy. Further, the ambiguity is caused by several factors such as indistinguishable call states in one carrier, diversity across unknown carriers (the same pattern means different states in different carriers), user-induced diversity (user setting affecting the pattern).

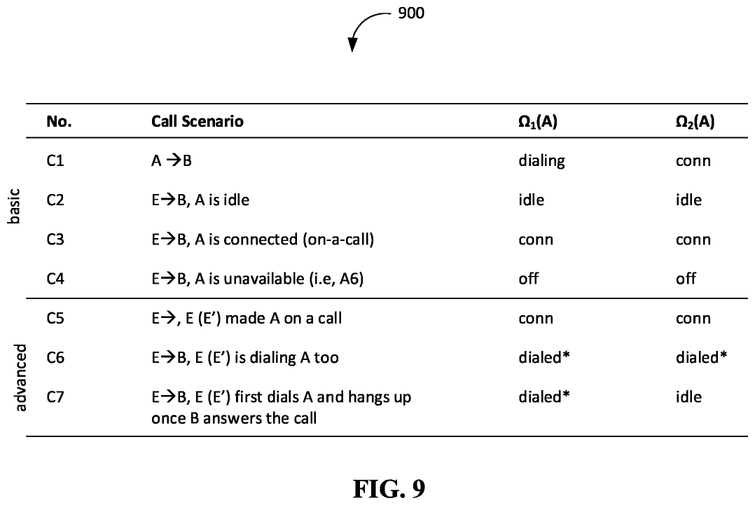

First, Multi-phase reduces the N/A likelihood when a certain call state is not distinguishable. The N/A probability is the product of N/A ones at all the phases and greatly reduces with more phases. In this work, the present disclosure may run two-phase verification before and after the call is accepted. FIG. 9 depicts seven typical call scenarios including one no-spoof scenario and several basic and advanced spoofing ones, in accordance with exemplary embodiments. Here, only C1 is the no-spoof case. For example, in C2, even when idle is not distinguishable from dialing at phase one, it is detectable as long as conn and idle may be distinguished. This allows the present disclosure to tolerate coarse-grained call state inference to some extent. For example, when E dials A in C6 to cheat the verification at the first phase, the present disclosure may still infer the spoofing at the next phase.

Second, multi-phase verification combines patterns and gets a longer feature vector which combats ambiguity caused by unknown factors. Though A's carrier or other factors are unknown to B, the resulting sequences convey additional information constrained by these unknown factors. Further, a two-carrier two-phase example illustrates this idea. Let Pᵢ be the observed pattern while Ωᵢ(X) is dialing. Assume that Pᵢ is labeled as idle (carrier 1) but dialing (carrier 2). Without running more phases, it is believed to be a match with ambiguity and ends with N/A (as shown in FIG. 7). If the present disclosure runs another phase when Ωᵢ₊(X) is conn, the present disclosure obtains a new observation Pi+1 that may be conn (carrier 1) but cannot be conn (carrier 2). Combining both observations, the present disclosure may infer that Pᵢ+P₁₊₁ may not be dialing+conn for either carrier. Further, the present disclosure may ascertain that it is a spoof.

Further, two-phase verification has already achieved 100% accuracy when the spoofing occurs (except in the stretched attack) using single call action (either VoLTE or CSFB). The present disclosure may run more phases as long as each has distinct Ωᵢ(X) and πᵢ (e.g., using hybrid (both VoLTE and CSFB), WiFi calling, voice-over-IP (VoIP), and other well-designed calling schemes).

Re-Learning and Other Components

The present disclosure also supports learning during the use. This ability is important when the initial training is not sufficient and does not capture key patterns. This also makes the present disclosure extensible to new settings (for example, a call from a new carrier that has not been studied before). With re-learning, the present disclosure is able to evolve itself and improve accuracy even if it performs poorly at the start. Re-learning requires user feedback. After one call, the present disclosure allows for the labeling of the call. Further, the present disclosure may take the same iterative approach in initial training to update the classifiers. Upon a new sample, the present disclosure may add this pattern if it never appears, or update the relevant rules if it appears before. If it is consistent with the existing rules, no update is needed. Otherwise, the present disclosure may update its label of call status and re-extract the feature (say, the first distinct subsequence). The present disclosure suffers from incorrect samples (e.g., marking a no-spoof as a spoof). This may produce wrong ambiguity and mislead the present disclosure's inference. Currently, the present disclosure works with correct samples only. When a small portion of samples are polluted, the present disclosure may apply advanced classification techniques (say, majority voting classifiers).
Other triggers for the present invention. Currently, the present disclosure is invoked by any incoming calls. It is extensible to other trigger conditions. For example, the user may configure not to run the present disclosure when the numbers associated with the call are from personal contacts, whitelists, call history, etc. Billing is another critical factor. In countries where the user needs to pay extra costs for outgoing calls, the present disclosure may be more conservative to make auCalls and even do not run when the call is from one international number or one premium number, etc. Further, the present disclosure just dials auCalls and hangs up before the auCalls get through in most cases, which will not incur extra charges. Moreover, it may work with the existing solutions which mark some suspecting numbers.
What if A (the caller) also enables the present disclosure? The present disclosure does not require additional support from A. But it should work gracefully in this case. Further, the present disclosure may avoid the chain effect (B calls A, A calls B, and into a loop) by allowing at most one active verification test for one number at one time. So even when A calls back to B, B will not a invoke new verification call.

Flexible Deployment Modes

The present disclosure may offer multiple modes of deployment. It may be readily implemented in mobile devices, the network infrastructure, or both. This flexibility helps the callees immediately benefit with an incremental in-device deployment while facilitating the large-scale deployment at the callee's network or by massive callees. Specifically, there are three deployment modes:
Mode 1: In-device deployment. A callee may directly deploy the present disclosure on the devices associated with the callee (e.g., smartphones and telephones) without cellular operator or infrastructure's support. To do so, the present disclosure addresses three practical issues. First, the current cellular network does not allow another dialing when being dialed. B thus cannot make a call to A while receiving an incoming call request. The present disclosure uses a buddy phone B*. Further, the B* may be associated with a family number, a friend or buddy trusted by B. When B makes a call during dialing, B forwards this request and associated information to the B*. Further, the B* will do it exactly as designed on B and then return results to B. Further, the buddy option will not cause any chain effect when both A and B use the present disclosure. This is because the incoming call will not show up when the phone is dialing or being dialed. In the absence of spoofing, A will not see a request from B*. In the presence of spoofing, A may ask A* to call B* upon receiving the request from B*. This call will not show up at B*, because B* is dialing.

Second, cellular networks and some OS (e.g., Android) permit two calls but do not allow both active simultaneously. The incoming call is put on hold when B makes another new call and gets resumed when the new call ends. This slightly affects user experience. To program voice call services, the present disclosure uses TELEPHONY_SERVICE, a system service in TelephonyManager to monitor any incoming call and obtain phone information. It uses ACTION_CALL in Android Intent to launch a new verification call, which automatically places the prior incoming call on hold. Further, the present disclosure terminates the verification call once having sufficient information for spoofing inference. Last, commodity OS (Android, iOS, etc) does not open permissions to obtain cellular signaling messages. Further, the present disclosure uses rooted phones at the B's buddy phone to monitor call setup signaling messages. Further, the present disclosure is extensible to a service that provides the phone buddies to actively verify the caller of any incoming call upon the request of one callee, while the callee reports the call information to the verification service as it did on its own device.
Mode 2: In-infrastructure deployment. A cellular network operator may also deploy the present disclosure inside the infrastructure of the cellular network. This mode will benefit all the users (as callees) of the cellular network, especially the users that do not deploy the present disclosure in the devices. In this mode, the cellular operator deploys the present disclosure at the circuit-switched mobile switch center (MSC) for CSFB/CS calls, or packet-switched voice call infrastructure (e.g. call session control function (CSCF) in IMS for VoLTE calls. By reusing the capabilities in MSC or CSCF, the in-infrastructure model may directly access the per-callee signaling messages from MSC and CSCF, launch a secondary dialing for verification without interrupting the callees' ongoing call, and support two active calls. This differs from mode 1 and offers more accurate and seamless call spoofing defenses. More importantly, the carrier may provide different call plans and options which may or may not filter out all the incoming call requests that are detected as spoofed calls upon users' explicit consent.
Mode 3: Joint deployment. The present disclosure may also be jointly deployed by the callee's device and operator's infrastructure. Compared with mode 1 and 2, this joint mode simplifies the device-side deployment and helps offload the detection/verification overhead from infrastructure to the devices. Specifically, for the contract phones provided by the operators, the present disclosure may be integrated as a system app, thus bypassing the root requirement in mode 1. For such contract phones, the infrastructure will disable the caller ID spoofing detection and verification (based on the in-device digital signature) and relies on the device to defend the attacks. For other phones, the infrastructure will roll back to mode 2 and enable infrastructure-side defense.

According to some aspects, a callee-implemented method is disclosed. The method includes receiving an incoming call request from one caller, dialing one or multiple verification call sessions towards the caller ID observed in the incoming call, monitoring the call setup signaling data associated with the verification call sessions, inferring call states in the incoming call and the verification call sessions using the rules trained in advance, and determining the presence or absence indication out of the inferred call states, and taking actions upon the detected results.

According to further aspects, the callee is a phone device of the receiving party, or the carrier network of the receiving party, or both.

According to further aspects, the core module in the present disclosure is a spoof-verifier for runtime call spoof detection when an incoming call comes and the output of the spoof-verifier is an indication, which allows carrying a non-numeric or numeric confidence level to alert the callee human when the detection is not 100% certain.

According to further aspects, the method leaves flexibility to the callee upon the detected indication, to take a variety of actions including but not limited to forwarding the indication of a spoof call to the callee human (user), rejecting the call directly, semi-automatically rejecting the call if no explicit operations from the callee human within a time window, or connecting to other actions customized, subscribed or pre-configured by the callee human.

According to further aspects, a spoof verifier includes a multi-phase verification strategy and one-time verification, an initial training engine that trains the decision tree rules used by the verifier, and a re-learning module that updates the decision tree rules for the spoof verifier.

According to further aspects, multi-phase (mostly two-phase) verification strategy dials each verification call at different phases with different incoming call states and/or under distinct call settings known to the callee.

According to further aspects, one-run verification dials an outgoing call (not necessarily to make this call through) to the received caller number, infer the call states using the call setup signaling messages observed at the callee side without any extra information and assistance from a non-callee component in the telephony systems and compare it with the expected call state associated with the incoming call.

According to further aspects, the modules of initial training and re-learning in the method are to train and update decision tree rules (classifiers) used by spoof-verifier;

According to further aspects, the training is to develop classifiers to infer the call states of the callee out of the call setup signaling data observed at the caller, composing: extracting patterns out of the call setup signaling data and deriving classification rules over the extracted patterns.

According to further aspects, the training is performed in an incremental and evolving manner without requiring all the training samples prior to any use, and training is allowed in both individual and crowdsourced manners where the training may be performed by one single callee, or accumulated over the training results of multiple callees.

According to further aspects, the method works for any voice call technology used by cellular networks including voice calls over IP (VoLTE) and CS/CSFB calls and any voice call technology in non-cellular networks where the callee's call states are inferable out the call setup signaling data invoked by dialing verification calls.

According to further aspects, the method offers three deployment modes: in-device mode which includes single-device deployment or a service over a number of cooperated devices without the carrier network being involved), in-network where the invented method is purely implemented on the network infrastructure, and joint mode.

According to some embodiments, the present disclosure provides a practical solution that may effectively defend the caller ID spoofing attacks with callee-only capability. It is totally different from existing solutions, and outperform the existing solutions in at least four aspects. First, it does not require global authentication infrastructure or heavy infrastructure upgrades and thus may be deployed at a low cost. Second, it does not require cooperation from the caller or the caller's carrier network and may be achieved by callees only. Third, rather than focus on specific caller spoofing attacks, the present disclosure covers a large class of practical spoofing attacks against voice call users, as long as the caller ID used in the incoming call is not associated with the true caller. Last but not the least, it offers multiple deployment options in either the callees' devices or the network infrastructure that serves the callees.

According to some embodiments, the present disclosure provides a first solution that effectively defends against caller ID spoofing attacks with callee-only capability (thus low deployment costs). The callee-only capability refers to the callee phone or the callee-carrier network only. Without loss of generality, the callee phone may be used to illustrate the present disclosure and the proposed method is applicable and deployable at the callee's carrier network.

According to some embodiments, the disclosed method includes initiating a callback session to the originating phone number and comparing the call states of the outgoing call session with the incoming call session. The goal is to verify whether the claimed caller ID indeed matches the actually used one. Specifically, upon receiving an incoming call request session inCall with a potentially spoofed phone number, the (victim) callee initiates a callback session auCall before accepting the incoming call. In the absence of caller ID spoofing, the callee of auCall is identical to the caller of inCall. In the presence of caller ID spoofing, auCall will reach another party different from inCall.caller, and the user can consequently reject the call once it detects this difference in their call states. To make this detection (verification) more reliable, the present disclosure infers the fine-grained call state of auCall.callee including dialing, idle, on-a-call (connected), and other), in order to assert whether it matches the anticipated one of inCall.caller. Further, the present disclosure exploits an available, yet unexplored side channel. Another salient feature of the present disclosure is that it has to infer the inCall.caller state based on the victim-side information only, without requiring any cooperation from the caller side or the additional infrastructure support on the caller's carrier network. Note that the caller can be malicious and untrustworthy.

According to some embodiments, the present disclosure formulates its core design as an inference problem and further devises novel techniques to make this inference accurate and robust by tackling three practical challenges. First, inferring the call state of auCall.callee only from auCall.caller's observation is difficult. Common features (e.g., call/phone states) observed from mobile phones would not work; they can inform the local caller's state, but are insufficient to infer the remote callee's call state. To this end, the present disclosure uses an unexplored side channel of call setup signaling, which is proved feasible to infer certain call states out of the sequence of observed signaling messages. Second, inference accuracy is affected by many factors unknown to auCall.caller. The sequence of call setup signaling messages varies with carriers, call technologies, call settings, and even seemingly-random factors (controlled by network operations). For example, the same sequence is observed for two distinct call states (e.g., dialing or being-dialed); Multiple sequence variants are observed for the same call state. The present disclosure enhances spoofing verification with inference, and design an inference engine tailored to caller ID spoofing detection. In doing so, the present disclosure enables a coarse-grained inference to learn a few, but not all call states, which suffice to differentiate spoof from no-spoof using machine learning techniques in most usage scenarios. Third, a single inference-verification phase may still fail to resolve ambiguity in certain scenarios, especially when the adversary designates special attacks against defense to manipulate call states (e.g., making the authentic caller busy or stuck at certain hard-to-differentiate state). The present disclosure employs multiple-phase (mostly two) verification and leverages delta and coherence across phases to refine inference. Finally, it applies re-learning for automated evolution. The present disclosure offers multiple deployment modes. It can be readily deployed in the callees' mobile devices, integrated into the callees' network carriers' infrastructure, or both. Such flexibility helps the victim callees to immediately benefit from the present disclosure and facilitates quick protection for a few callees who install the proposed detection and defense method as a software application on their phones. This also allows the callees' carriers to implement a large-scale deployment inside its network to protect their massive callee subscribers on their demands/voice call plans.

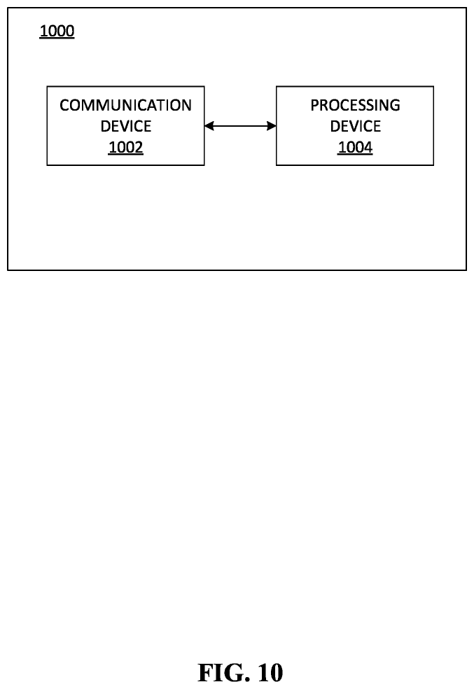

FIG. 10 is a block diagram of a callee device 1000 for facilitating managing connections from one or more caller devices, in accordance with some embodiments. Further, the callee device 1000 may be connectable to one or more caller devices for establishing a connection with the one or more caller devices. Further, the connection may include a call session. Further, the call session may include an incoming call session, an outgoing call session, auxiliary call sessions, etc. Further, the callee device 1000 may include a communication device 1002 and a processing device 1004. Further, the callee device may include a smartphone, a phone, a mobile phone, a telephone, etc. Further, the one or more caller devices may include smartphones, mobile phones, phones, telephones, etc.

Further, the communication device 1002 may be configured for receiving a first connection request associated with a first connection from a first caller device of the one or more caller devices. Further, the first connection request may include a caller identification associated with the first caller device. Further, the caller indication may include a unique identification associated with the first caller device. Further, the unique identification may include a telephone number, a device number, etc. Further, the communication device 1002 may be configured for receiving at least one signaling message from a second caller device of the one or more caller devices.

Further, the processing device 1004 may be configured for initiating a second connection to the second caller device based on the caller identification. Further, the processing device 1004 may be configured for determining an inferred call state associated with the second caller device based on the at least one signaling message. Further, the inferred call state may include a dialing state, a being dialed state, a not-on-hold connected state, a connected on-hold state, an idle state, an unreachable state, etc. Further, the processing device 1004 may be configured for comparing an expected call state of the first caller device and the inferred call state based on the determining of the inferred call state. Further, the expected call state may include a dialing state, a being dialed state, a not-on-hold connected state, a connected on-hold state, an idle state, an unreachable state, etc. Further, the processing device 1004 may be configured for determining an indication of spoofing associated with the first caller device based on the comparing. Further, the indication of the spoofing may include a spoof, a not spoof, a to-be-determined, and a not available, etc. Further, the processing device 1004 may be configured for performing at least one action based on the determining of the indication of the spoofing. Further, the at least one action may include rejecting the first connection, accepting the first connection, diverting the first connection, etc.

Further, in some embodiments, the second connection may be associated with a side channel Further, the receiving of the at least one signaling message may be over the side channel.

Further, in some embodiments, the processing device 1004 may be configured for training at least one classifier based on the at least one signaling message. Further, the at least one classifier may be configured for inferring a call state of the inferred call state based on the at least one signaling message. Further, the determining of the inferred call state may be based on the at least one classifier.

Further, in some embodiments, the processing device 1004 may be configured for collecting the at least one signaling message. Further, the at least one signaling message may include at least one segment. Further, each segment of the at least one segment may be may include at least one signaling command and at least one response code. Further, the at least one signaling command may include INVITE, ACK, OPTION, BYE, CANCEL, PRACK, UPDATE, etc. Further, the at least one response code may include at least one numeral such as 100, 183, 180, 200, and so on. Further, the processing device 1004 may be configured for extracting a pattern of the at least one signaling message based on the collecting. Further, the pattern may include a primary and a secondary segment. Further, the processing device 1004 may be configured for training at least one classifier based on the extracting. Further, the at least one classifier may be configured for inferring a call state of the inferred call state. Further, the at least one classifier may be configured for inferring the indication of the spoofing. Further, the determining of the inferred call state may be based on the at least one classifier. Further, in an embodiment, the pattern may include a plurality of patterns. Further, the training may include mapping each pattern of the plurality of patterns with a call state of the inferred call state. Further, in an embodiment, the callee device 1000 may include at least one user interface. Further, the user interface facilitates an interaction between a user (such as the user 1212) and the callee device 1000. Further, the interaction may include a communication between the callee device 1000 and the user. Further, the callee device 1000 may be configured for generating at least one feedback based on the interaction. Further, the at least one feedback may include the indication of the spoofing associated with the first caller device. Further, the processing device 1004 may be configured for updating the at least one classifier based on the at least one feedback.

Further, in some embodiments, the expected call state may include a plurality of expected call states associated with the first caller device. Further, the processing device 1004 may be configured for modifying a first expected call state associated with the first caller device to a second expected call state associated with the first caller device. Further, the communication device 1002 may be configured for receiving at least one additional signaling message from the second caller device based on the modifying. Further, the determining of the inferred call state may be based on the at least one additional signaling message. Further, in an embodiment, the indication of the spoofing may include a plurality of indications of the spoofing. Further, the inferred call state may include a plurality of inferred call states. Further, the processing device 1004 may be configured for determining a first inferred call state of the plurality of inferred call states associated with the second caller device based on the at least one additional signaling message. Further, the processing device 1004 may be configured for comparing the first expected call state and the first inferred call state. Further, the processing device 1004 may be configured for determining a first indication of the plurality of indications based on the comparing. Further, the performing of the at least one action may be based on the determining of the first indication of the spoofing.

Further, in some embodiments, the processing device 1004 may be configured for analyzing the first connection request based on at least one predetermined criterion. Further, the at least one predetermined criterion may at least one personal contact associated with the callee device 1000, at least one whitelist associated with the callee device 1000, a call history associated with the callee device 1000, etc. Further, the processing device 1004 may be configured for determining a trigger based on the analyzing. Further, the initiating of the second connection may be based on the determining of the trigger. Further, the callee device 1000 may include a storage device (not shown) communicatively coupled with the processing device 1004. Further, the storage device may be configured for storing the at least one predetermined criterion.

Further, in some embodiments, the callee device 1000 may be connectable with the one or more caller devices over at least one carrier network. Further, the establishing of the connection between the caller device and the one or more caller devices may be based on the at least one carrier network. Further, the at least one carrier network may include a 5G network, a 4G network, a 3G network, a 2G network, etc. Further, at least one of the 3G network and 2G network may be associated with a convention circuit switched call (connection). Further, at least one of the 4G network and the 5G network may be associated with Voice-over-LTE (VoLTE) and Circuit Switched FallBack (CSFB). Further, the VoLTE adopts Voice-over-IP (VoIP) and carries voice calls (connection) and signaling associated with the voice calls in IP packets. Further, the CSFB leverages legacy 3G/2G networks to provide CS voice calls (connection).

Further, in some embodiments, the callee device 1000 may be connectable with the one or more caller devices without at least one carrier network. Further, the callee device 1000 may be configured directly establishing the connection with the one or more caller devices without the at least one carrier network.

Further, in some embodiments, the at least one action may include generating at least one alert based on the indication of the spoofing. Further, the callee device 1000 may include a presentation device (not shown) communicatively coupled with the processing device 1004. Further, the presentation device may be configured for presenting the at least one alert.

Further, in some embodiments, the indication of the spoofing may include a presence of the spoofing and an absence of the spoofing. Further, the second caller device associated with the second connection may be identical to the first caller device associated with the first connection in the absence of the spoofing. Further, the second caller device associated with the second connection may be not identical to the first caller device associated with the first connection the presence of the spoofing.

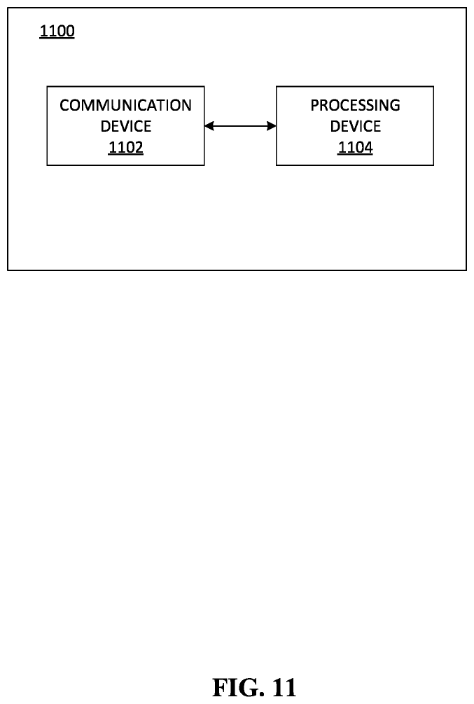

FIG. 11 is a block diagram of a callee device 1100 for facilitating managing connections from one or more caller devices, in accordance with some embodiments. Further, the callee device 1100 may be connectable to one or more caller devices for establishing a connection with the one or more caller devices. Further, the callee device 1100 may be configured for managing the connection. Further, the callee device 1100 may include a communication device 1102 and a processing device 1104.

Further, the communication device 1102 may be configured for receiving a first connection request associated with a first connection from a first caller device of the one or more caller devices. Further, the first connection request may include a caller identification associated with the first caller device. Further, the communication device 1102 may be configured for receiving at least one signaling message from a second caller device of the one or more caller devices.

Further, the processing device 1104 may be configured for initiating a second connection to the second caller device based on the caller identification. Further, the second connection may be associated with a side channel. Further, the receiving of the at least one signaling message may be over the side channel. Further, the processing device 1104 may be configured for determining an inferred call state associated with the second caller device based on the at least one signaling message. Further, the processing device 1104 may be configured for comparing an expected call state of the first caller device and the inferred call state based on the determining of the inferred call state. Further, the processing device 1104 may be configured for determining an indication of spoofing associated with the first caller device based on the comparing. Further, the processing device 1104 may be configured for performing at least one action based on the determining of the indication of the spoofing.

Further, in some embodiments, the processing device 1104 may be configured for training at least one classifier based on the at least one signaling message. Further, the at least one classifier may be configured for inferring a call state of the inferred call state based on the at least one signaling message. Further, the determining of the inferred call state may be based on the at least one classifier.

Further, in some embodiments, the processing device 1104 may be configured for collecting the at least one signaling message. Further, the at least one signaling message may include at least one segment. Further, each segment of the at least one segment may be may include at least one signaling command and at least one response code. Further, the processing device 1104 may be configured for extracting a pattern of the at least one signaling message based on the collecting. Further, the pattern may include a primary and a secondary segment. Further, the processing device 1104 may be configured for training at least one classifier based on the extracting. Further, the at least one classifier may be configured for inferring a call state of the inferred call state. Further, the at least one classifier may be configured for inferring the indication of the spoofing. Further, the determining of the inferred call state may be based on the at least one classifier.

Further, in some embodiments, the expected call state may include a plurality of expected call states associated with the first caller device. Further, the processing device 1104 may be configured for modifying a first expected call state associated with the first caller device to a second expected call state associated with the first caller device. Further, the communication device 1102 may be configured for receiving at least one additional signaling message from the second caller device based on the modifying. Further, the determining of the inferred call state may be based on the at least one additional signaling message.

Further, in some embodiments, the callee device 1100 may be connected with the one or more caller devices over at least one carrier network. Further, the establishing of the connection between the caller device and the one or more caller devices may be based on the at least one carrier network.

Further, in some embodiments, the at least one action may include generating at least one alert based on the indication of the spoofing. Further, the callee device 1100 may include a presentation device (not shown) communicatively coupled with the processing device 1104. Further, the presentation device may be configured for presenting the at least one alert.

Further, in some embodiments, the indication of the spoofing may include a presence of the spoofing and an absence of the spoofing. Further, the second caller device associated with the second connection may be identical to the first caller device associated with the first connection in the absence of the spoofing. Further, the second caller device associated with the second connection may be not identical to the first caller device associated with the first connection the presence of the spoofing.

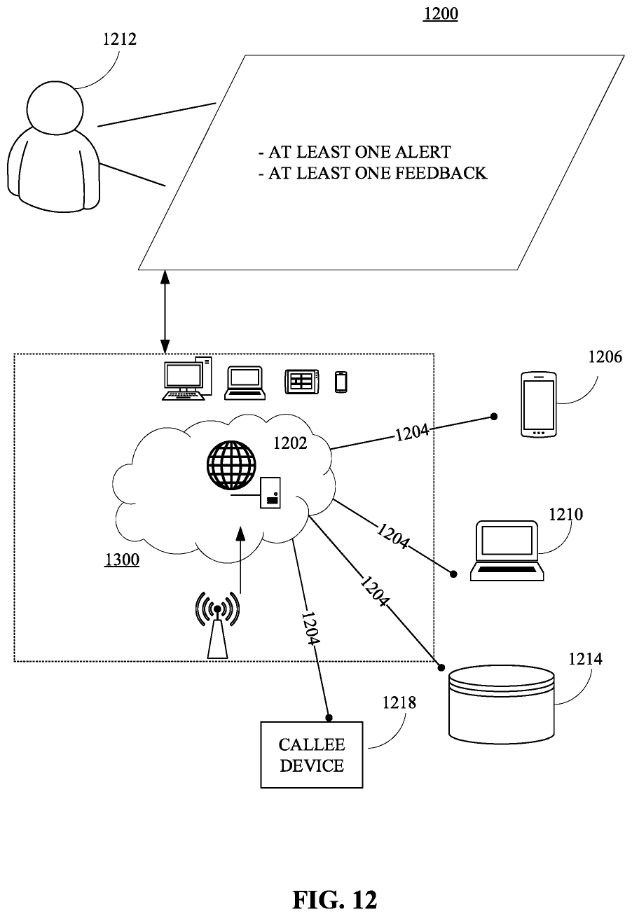

FIG. 12 is an illustration of an online platform 1200 consistent with various embodiments of the present disclosure. By way of non-limiting example, the online platform 1200 to facilitate managing connections from one or more caller devices may be hosted on a centralized server 1202, such as, for example, a cloud computing service. The centralized server 1202 may communicate with other network entities, such as, for example, a mobile device 1206 (such as a smartphone, a laptop, a tablet computer, etc.), other electronic devices 1210 (such as desktop computers, server computers, etc.), databases 1214, and a callee device 1218 (such as the callee device 1000 and the callee device 1100) over a communication network 1204, such as, but not limited to, the Internet. Further, users of the online platform 1200 may include relevant parties such as, but not limited to, callee, end-users, administrators, service providers, service consumers, and so on. Accordingly, in some instances, electronic devices operated by the one or more relevant parties may be in communication with the platform.

A user 1212, such as the one or more relevant parties, may access online platform 1200 through a web-based software application or browser. The web-based software application may be embodied as, for example, but not be limited to, a website, a web application, a desktop application, and a mobile application compatible with a computing device 1300.

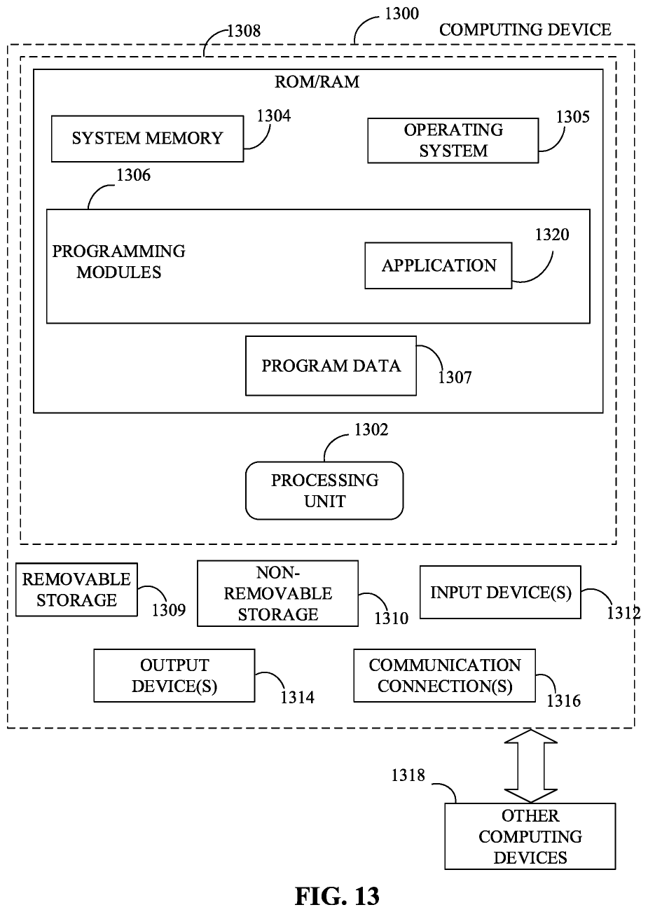

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A callee device connectable to one or more caller devices for establishing a secure connection with the one or more caller devices, wherein the callee device is configured for managing the connection and detecting a spoofed call, wherein the callee device comprises:
a communication device configured for:
receiving a first connection request associated with a first connection from a first caller device of the one or more caller devices, wherein the first connection request comprises a caller identification associated with the first caller device; and
receiving at least one signaling message from a second caller device of the one or more caller devices; and
a processing device configured for:
initiating a second connection to the second caller device based on the caller identification;
determining an inferred call state associated with the second caller device based on the at least one signaling message;
comparing an expected call state of the first caller device and the inferred call state based on the determining of the inferred call state;
determining an indication of spoofing associated with the first caller device based on the comparing; and
performing at least one action based on the determining of the indication of the spoofing.

2. The callee device of claim 1, wherein the second connection is associated with a side channel, wherein the receiving of the at least one signaling message is over the side channel.

3. The callee device of claim 1, wherein the processing device is further configured for training at least one classifier based on the at least one signaling message, wherein the at least one classifier is configured for inferring a call state of the inferred call state based on the at least one signaling message, wherein the determining of the inferred call state is based on the at least one classifier.

4. The callee device of claim 1, wherein the processing device is further configured for:
collecting the at least one signaling message, wherein the at least one signaling message comprises at least one segment, wherein each segment of the at least one segment is comprises at least one signaling command and at least one response code;
extracting a pattern of the at least one signaling message based on the collecting, wherein the pattern comprises a primary and a secondary segment; and
training at least one classifier based on the extracting, wherein the at least one classifier is configured for inferring a call state of the inferred call state, wherein the at least one classifier is configured for inferring the indication of the spoofing, wherein the determining of the inferred call state is based on the at least one classifier.

5. The callee device of claim 4, wherein the pattern comprises a plurality of patterns, wherein the training comprises mapping each pattern of the plurality of patterns with a call state of the inferred call state.

6. The callee device of claim 4, wherein the callee device comprises at least one user interface, wherein the user interface facilitates an interaction between a user and the callee device, wherein the callee device is configured for generating at least one feedback based on the interaction, wherein the at least one feedback comprises the indication of the spoofing associated with the first caller device, wherein the processing device is configured for updating the at least one classifier based on the at least one feedback.

7. The callee device of claim 1, wherein the expected call state comprises a plurality of expected call states associated with the first caller device, wherein the processing device is configured for modifying a first expected call state associated with the first caller device to a second expected call state associated with the first caller device, wherein the communication device is configured for receiving at least one additional signaling message from the second caller device based on the modifying, wherein the determining of the inferred call state is based on the at least one additional signaling message.

8. The callee device of claim 7, wherein the indication of the spoofing comprises a plurality of indications of the spoofing, wherein the inferred call state comprises a plurality of inferred call states, wherein the processing device is configured for:
determining a first inferred call state of the plurality of inferred call states associated with the second caller device based on the at least one additional signaling message;
comparing the first expected call state and the first inferred call state; and
determining a first indication of the plurality of indications based on the comparing, wherein the performing of the at least one action is based on the determining of the first indication of the spoofing.

9. The callee device of claim 1, wherein the processing device is configured for:
analyzing the first connection request based on at least one predetermined criterion; and
determining a trigger based on the analyzing, wherein the initiating of the second connection is based on the determining of the trigger, wherein the callee device comprises a storage device communicatively coupled with the processing device, wherein the storage device is configured for storing the at least one predetermined criterion.

10. The callee device of claim 1, wherein the callee device is connectable with the one or more caller devices over at least one carrier network, wherein the establishing of the connection between the caller device and the one or more caller devices is based on the at least one carrier network.

11. The callee device of claim 1, wherein the callee device is connectable with the one or more caller devices without at least one carrier network, wherein the callee device is configured directly establishing the connection with the one or more caller devices with out the at least one carrier network.

12. The callee device of claim 1, wherein the at least one action comprises generating at least one alert based on the indication of the spoofing, wherein the callee device further comprises a presentation device communicatively coupled with the processing device, wherein the presentation device is configured for presenting the at least one alert.

13. The callee device of claim 1, wherein the indication of the spoofing comprises a presence of the spoofing and an absence of the spoofing, wherein the second caller device associated with the second connection is identical to the first caller device associated with the first connection in the absence of the spoofing, wherein the second caller device associated with the second connection is not identical to the first caller device associated with the first connection the presence of the spoofing.

14. A callee device connectable to one or more caller devices for establishing a connection with the one or more caller devices, wherein the callee device is configured for managing the connection, wherein the callee device comprises:
a communication device configured for:
receiving a first connection request associated with a first connection from a first caller device of the one or more caller devices, wherein the first connection request comprises a caller identification associated with the first caller device; and
receiving at least one signaling message from a second caller device of the one or more caller devices; and
a processing device configured for:
initiating a second connection to the second caller device based on the caller identification, wherein the second connection is associated with a side channel, wherein the receiving of the at least one signaling message is over the side channel;
determining an inferred call state associated with the second caller device based on the at least one signaling message;
comparing an expected call state of the first caller device and the inferred call state based on the determining of the inferred call state;
determining an indication of spoofing associated with the first caller device based on the comparing; and
performing at least one action based on the determining of the indication of the spoofing.

15. The callee device of claim 13, wherein the processing device is further configured for training at least one classifier based on the at least one signaling message, wherein the at least one classifier is configured for inferring a call state of the inferred call state based on the at least one signaling message, wherein the determining of the inferred call state is based on the at least one classifier.

16. The callee device of claim 13, wherein the processing device is further configured for:
collecting the at least one signaling message, wherein the at least one signaling message comprises at least one segment, wherein each segment of the at least one segment is comprises at least one signaling command and at least one response code;
extracting a pattern of the at least one signaling message based on the collecting, wherein the pattern comprises a primary and a secondary segment; and
training at least one classifier based on the extracting, wherein the at least one classifier is configured for inferring a call state of the inferred call state, wherein the at least one classifier is configured for inferring the indication of the spoofing, wherein the determining of the inferred call state is based on the at least one classifier.

17. The callee device of claim 13, wherein the expected call state comprises a plurality of expected call states associated with the first caller device, wherein the processing device is configured for modifying a first expected call state associated with the first caller device to a second expected call state associated with the first caller device, wherein the communication device is configured for receiving at least one additional signaling message from the second caller device based on the modifying, wherein the determining of the inferred call state is based on the at least one additional signaling message.

18. The callee device of claim 13, wherein the callee device is connected with the one or more caller devices over at least one carrier network, wherein the establishing of the connection between the caller device and the one or more caller devices is based on the at least one carrier network.

19. The callee device of claim 13, wherein the at least one action comprises generating at least one alert based on the indication of the spoofing, wherein the callee device further comprises a presentation device communicatively coupled with the processing device, wherein the presentation device is configured for presenting the at least one alert.

20. The callee device of claim 13, wherein the indication of the spoofing comprises a presence of the spoofing and an absence of the spoofing, wherein the second caller device associated with the second connection is identical to the first caller device associated with the first connection in the absence of the spoofing, wherein the second caller device associated with the second connection is not identical to the first caller device associated with the first connection the presence of the spoofing.
